(19) United States
(12) Patent Application Publication
(10) Pub. No.: US 2008/0181141 A1
(43) Pub. Date: Jul. 31, 2008

(54) ENHANCED VOICEMAIL PROCESSING

(75) Inventors: Anton Krantz, Kirkland, WA (US); Niraj Khanchandani, Redmond, WA (US)

Correspondence Address: MERCHANT & GOULD (MICROSOFT), P.O. BOX 2903, MINNEAPOLIS, MN, 55402-0903, US

(73) Assignee: MICROSOFT CORPORATION, Redmond, WA (US)

(21) Appl. No.: 11/627,564

(22) Filed: Jan. 26, 2007

(51) Int. Cl. H04M 3/533

(52) U.S. Cl. 370/271

(57) ABSTRACT

Aspects of the present invention are generally directed to providing convenient access to contextual information related to one or more voicemail messages. In this regard, a user interface that presents contextual information related to a user's voicemail messages is implemented on an IP phone. The user interface is configured to receive contextual information from a remote device that manages the user's voicemail box. Based on contextual information displayed, input to navigate between the one or more voicemail messages may be received. For example, a user may selectively identify voicemail messages represented on the user interface that will be played. Moreover, a user may generate commands from the user interface for navigating between the voicemail messages.

### BACKGROUND

Generally described, an Internet telephony system provides an opportunity for users to have a call connection with enhanced calling features compared to a conventional Public Switched Telephone Network (PSTN) based telephony system. In a typical Internet telephony system, often referred to as Voice over Internet Protocol (VoIP), audio information is processed into a sequence of data blocks, called packets, for communications utilizing an Internet Protocol (IP) data network. During a VoIP call conversation, the digitized voice is converted into small frames of voice data and a voice data packet is assembled by adding an IP header to the frame of voice data that is transmitted and received.

VoIP technology has been favored because of its flexibility and portability of communications, ability to establish and control multimedia communication, and the like. VoIP technology will likely continue to gain favor because of its ability to provide enhanced calling features and advanced services. In this regard, service providers may implement a voicemail system that allows a caller to leave an audio and/or multimodal message (e.g., audio with an electronic file) for a callee. For example, service providers may allow a caller to leave a voicemail message in a designated area of storage known as a “voicemail box” that is accessible from a networked device.

In traditional systems, a user may access a voicemail box and listen to voicemail messages from an audio menu. For example, from an IP telephone, a user may establish a communication channel with a remote device to access various voicemail services. When the voicemail system is accessed, the user may be required to navigate an audio menu that provides information about the user's received voicemail messages. Unfortunately, existing audio menus are difficult to navigate as a user may only be able to provide audio input in response to a prompt. Also, a user may provide input by activating buttons on a hardware device that is processed using tonal recognition technology. In either instance, the user provides input in response to a series of prompts that define how the audio menu is navigated.

Another limitation of traditional voicemail systems is an inability to conveniently access a set of contextual information about one or more received voicemail messages from a preferred device. For example, a user may want to concurrently review a set of contextual information associated with all of the user's received voicemail messages. The contextual information may identify the caller, the subject matter of the voicemail message, the assigned importance of the voicemail message, and the like. If this type of contextual information was made available to a user from a preferred device, such as an IP phone, than the user may be able to easily prioritize and quickly process all received voicemail messages.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

Aspects of the present invention are generally directed to providing convenient access to contextual information related to one or more voicemail messages. In this regard, a user interface that presents contextual information related to a user's voicemail messages is implemented on an IP phone. The user interface is configured to receive contextual information from a remote device that manages the user's voicemail box. Based on contextual information displayed, input to navigate between the one or more voicemail messages may be received. For example, a user may selectively identify voicemail messages represented on the user interface that will be played. Moreover, a user may generate commands from the user interface for navigating between the voicemail messages.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIGS. 1A-B illustrate a networking environment in which aspects of the present invention may be implemented;

FIGS. 2A-B illustrate exemplary user interfaces for interacting with the user in accordance with one embodiment of the present invention;

FIGS. 3A-B illustrate an exemplary routine for authenticating a user in accordance with another embodiment of the present invention; and

FIGS. 4A-D illustrate the exchange of control information between remote devices that occurs when commands to navigate between voicemail messages are received.

### DETAILED DESCRIPTION

Prior to discussing the details of the invention, it should be understood that the following description is presented largely in terms of logic and operations that may be performed by conventional computer components. These computer components, which may be grouped in a single location or distributed over a wide area, generally include computer processors, memory storage devices, display devices, input devices, etc. In circumstances where the computer components are distributed, the computer components are accessible to each other via communication links. The following description first provides an overview of a system in which the present invention may be implemented. Then methods for accessing enhanced calling features of a voicemail system from the user interface of an IP phone are described. The illustrative examples described herein are not intended to be exhaustive or to limit the invention to the precise forms disclosed. Similarly, any steps described herein may be interchangeable with other steps, or several combinations of steps, in order to achieve the same result.

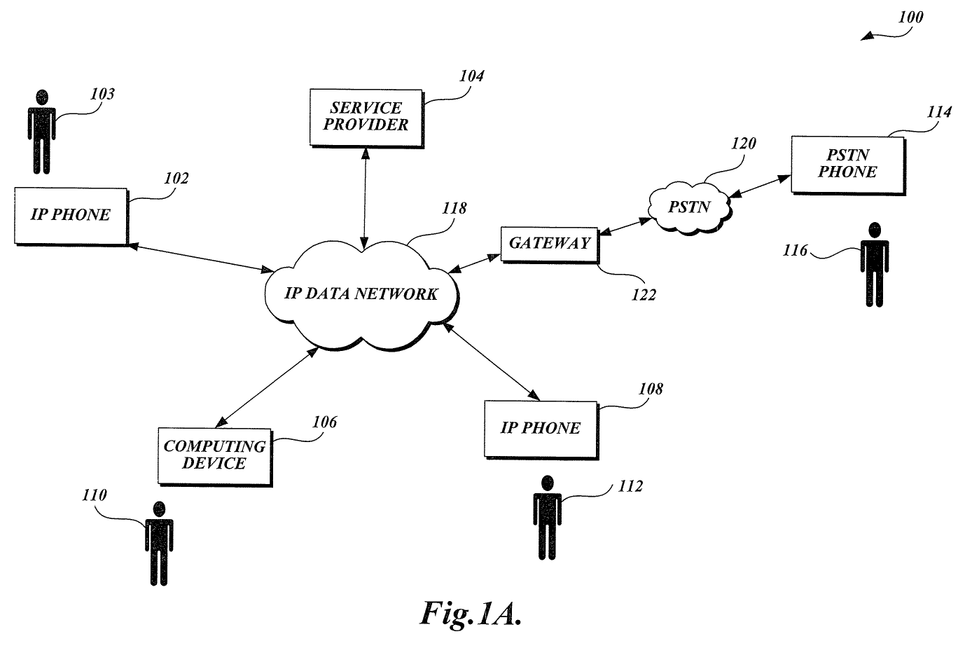

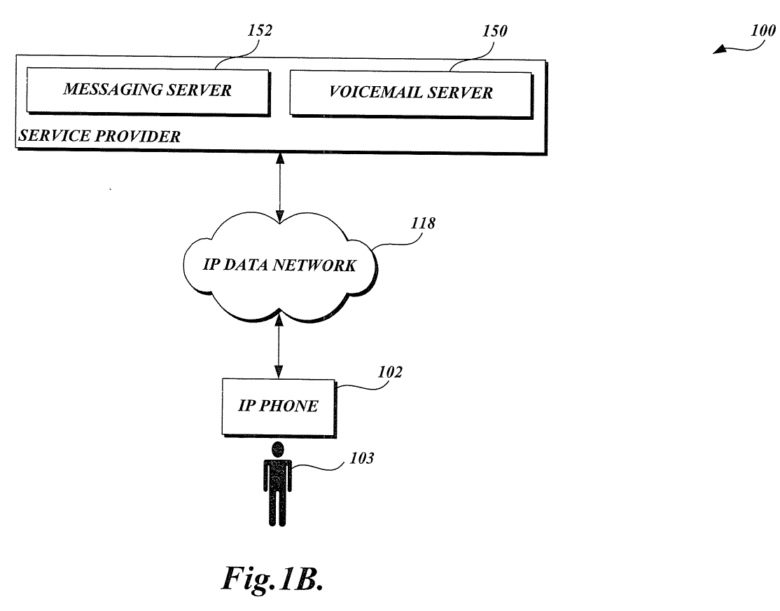

With reference to FIG. 1A, a block diagram of a networking environment 100 for providing enhanced voicemail services is shown. In this regard, the networking environment 100 includes the IP phone 102 associated with the user 103. In one embodiment, the service provider 104 implements a voicemail system that provides voicemail services to the user 103. Also, the networking environment 100 depicted in FIG. 1A includes the computing device 106 and IP phone 108 that are each associated with the users 110 and 112, respectively. By way of example only, the computing device 106 may be a desktop computer, laptop computer, mini- and mainframe computer, server computer, hand-held computing device such as a personal digital assistant or tablet, microprocessor-based and/or programmable consumer electronics including media systems, set-top boxes, gaming systems, or any other computing device capable of capturing audio data for transmission over a network connection. Also depicted in FIG. 1A is the PSTN phone 114 that is associated with the user 116.

Generally described, the networking environment 100 may include an IP data network 118 such as the Internet, an intranet network, a wide area network (WAN), a local area network (LAN), and the like. Network endpoints may be configured to establish and maintain communication channels over the IP data network 118. In this regard, the PSTN phone 114 may transmit data over the IP data network 118 via the PSTN 120. Those skilled in the art and others will recognize that the gateway 122 may translate IP data packets from the IP data network 118 into circuit switched network data suited for transmission over the PSTN 120 and vice versa. In this way, the gateway 122 enables communications between the PSTN phone 114 and other network endpoints, including the IP phone 102.

In the networking environment 100 depicted in FIG. 1A, the computing device 106, IP phone 108, and PSTN phone 114 may each be employed to leave a voicemail message for the user 103. By way of example only, the service provider 104 may allow a caller to leave a voicemail message in a voicemail box. One aspect of the present invention is directed at software that processes received voicemail messages to provide enhanced features. To this end, when a voicemail message is received, contextual information associated with the message (e.g., the identity of the caller, subject, importance, date/time, and the like) is identified. Instead of being required to access an audio menu to obtain contextual information associated with new voicemail messages, the contextual information may be directly transmitted from the service provider 104 to the IP phone 102. The contextual information may be initially transmitted without audio data that is included in the body of a received voicemail message. Based on the received contextual information, the user 103 may selectively identify voicemail messages that the user wants to play from the user interface of an IP phone. As a result, aspects of the present invention allow the user 103 to only listen and otherwise access voicemail messages that are of interest.

With reference now to FIG. 1B, an exemplary exchange of data in the networking environment 100 depicted in FIG. 1A will be described. While FIG. 1B only depicts the IP phone 102 and computing devices associated with the service provider 104, this is for illustrative purposes only. In the exemplary embodiment depicted in FIG. 1B, a voicemail server 150 and a messaging server 152 are associated with the service provider 104. As described above, a voicemail message may be received from a user associated with the IP phone 102 (e.g., user 103) in a voicemail box that is maintained by the service provider 104.

In accordance with one embodiment, the service provider 104 maintains a computer configuration in which the voicemail server 150 stores audio data associated with a user's voicemail messages. In this regard, the voicemail server 150 maintains designated areas of storage (“voicemail box”) that correspond to particular users. In this configuration, the messaging server 152 performs processing when a voicemail message for a user is received. More specifically, contextual information associated with a received voicemail message is identified and stored in a data store maintained by the messaging server 152. While FIG. 1B depicts two types of computing devices to provide enhanced voicemail services, those skilled in the art will recognize that the functions performed may be implemented on additional devices or on a single device without departing from the scope of the claimed subject matter.

Contextual information associated with the user's voicemail messages may be accessed without the user being required to navigate an audio menu. As described in further detail below, the IP phone 102 may periodically “poll” the messaging server 152 to obtain contextual information associated with a user's voicemail messages. In one embodiment, the present invention provides a user interface on the IP phone 102 for displaying the contextual information and obtaining input from the user. In this regard, contextual information maintained by the messaging server 152 may be presented on the user interface. For example, entries for one or more voicemail messages may be presented on the IP phone 102 that include the caller, subject, assigned importance, status, time, and duration for each of the user's voicemail messages. Based on the displayed contextual information, the user may activate controls to, for example, obtain additional contextual information, play the body of one or more voicemail messages, and/or initiate a call to the author of a voicemail message.

In one embodiment, the messaging server 152 provides a Web service for accessing contextual information related to a user's voicemail messages. Those skilled in the art and others will recognize that a Web service refers to a software system with a network accessible interface that performs actions on behalf of a remote device. A Web service is typically accessed using standard network protocols such as the Simple Object Access Protocol (“SOAP”). In this regard, the IP phone 102 interacts with a Web service provided by the messaging server 152 in order to obtain contextual information about a user's voicemail messages. For example, from the IP phone 102, a function exposed on the messaging server 152 may be activated to obtain contextual information associated with the user's new voicemail messages. When the function invoked on the messaging server 152 completes executing, the requested data is transmitted from the messaging server 152 to the IP phone 102 for display on a user interface.

From the user interface available from the IP phone 102, a control to listen to one or more received voicemail messages may be selected. In response to this type of request, a communication channel is established between the IP phone 102 and the voicemail server 150 for transmitting the body of a selected voicemail message. In this regard, control information is exchanged between the IP phone 102 and voicemail server 150 to establish the communication channel. For the purpose of discussion, a communication channel, as used herein, generally refers to any type of data or signal exchange mechanism. In this regard, the Session Initiation Protocol (“SIP”) is an exemplary protocol for initiating, modifying, and terminating a communication channel that involves media streams. However, those skilled in the art and others will recognize that other protocols may be used to exchange control information for the purpose of establishing a communication channel. In this regard, and by way of example only, control information may be exchanged in accordance with alternative embodiments of the present invention utilizing Web services with the Simple Object Access Protocol (“SOAP”) among other currently available systems of network communication.

FIG. 1B illustrates a networking environment 100 where the service provider 104 uses the voicemail server 150 to provide access to audio and the messaging server 152 to provide access to contextual information. However, those skilled in the art and others will recognize that the networking environment 100 depicted in FIGS. 1A-1B is merely exemplary. For example, the functionality performed by the voicemail server 150 and messaging server 152 may be integrated into the same computing device. Moreover, aspects of the present invention may, and typically will, be implemented in a “server farm” in which coordinated computers perform “load-balancing” when providing voicemail services to a vast number of users. Thus, the exemplary computer architecture provided above with reference to FIGS. 1A-1B should not be construed as limiting.

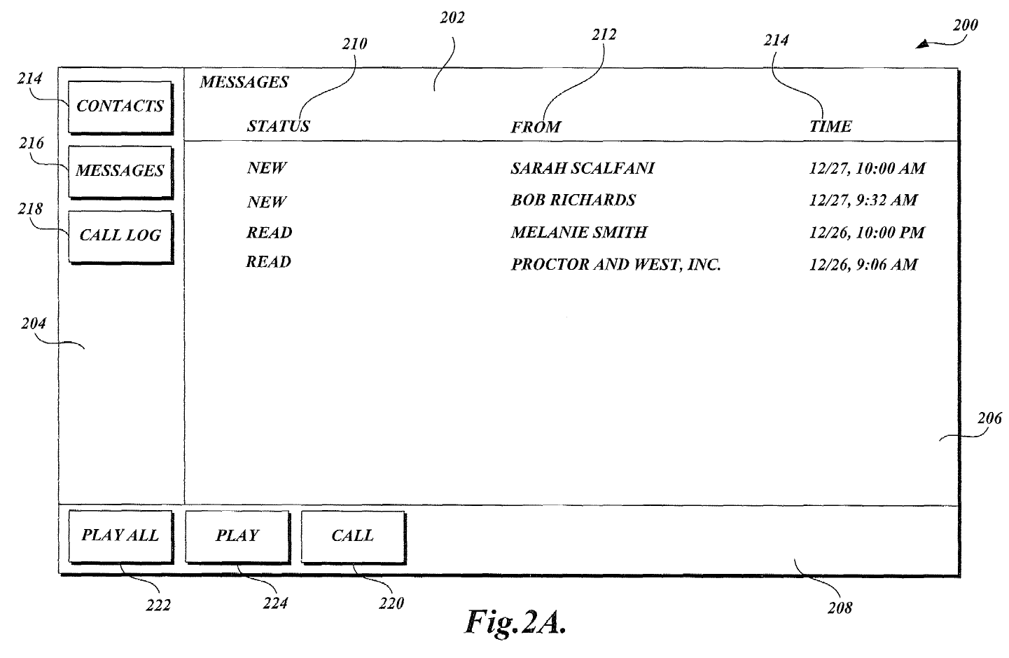

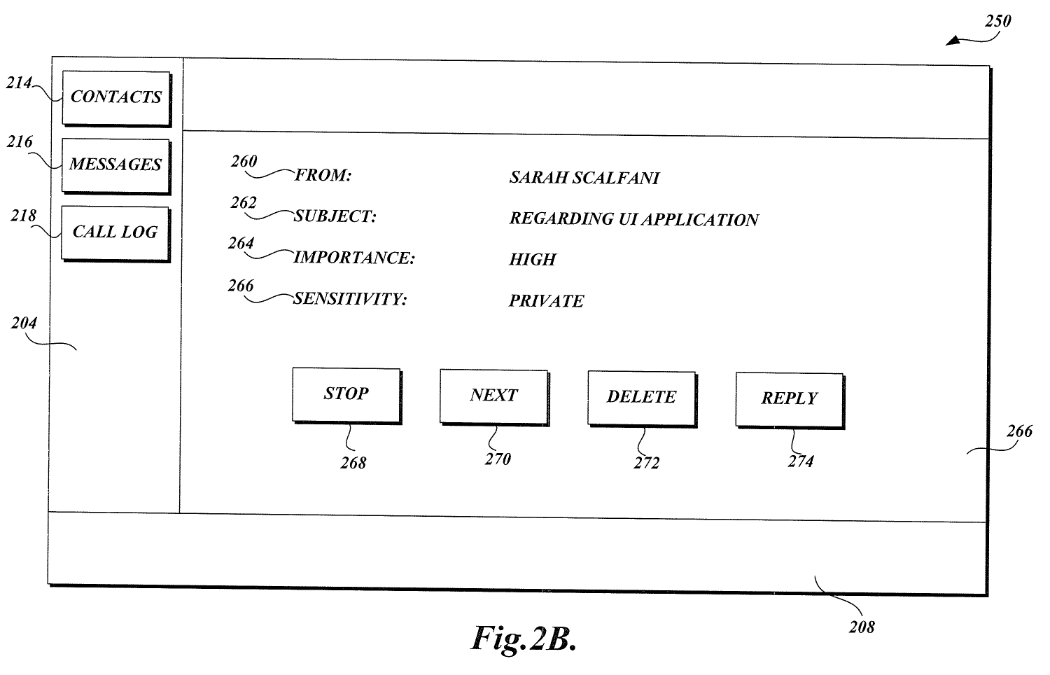

Now with reference to FIGS. 2A-2B, exemplary graphically-based user interfaces (GUIs) 200 and 250 that may implement aspects of the present invention will be described. With existing systems, a user is not able to easily obtain contextual information associated with voicemail messages from an IP phone. In this regard, a user may want to access contextual information about each received voicemail message without having to navigate an audio menu. However, existing IP phones are limited and do not provide controls for accessing contextual information. As mentioned previously, aspects of the present invention may implement a user interface on an IP phone, such as the IP phone 102, which provides convenient access to contextual information associated with a user's voicemail messages. In this regard, a user may interact with the user interfaces using a variety of hardware based controls. In one embodiment, controls available from a user interface are accessible from a touch screen display. However, those skilled in the art will recognize that other hardware systems may be used to obtain input from the user.

FIG. 2A depicts a selection user interface 200 that includes a field region 202, a sidebar region 204, an identification region 206, and a control region 208. In this example, the field region 202 includes a “STATUS” field 210, “FROM” field 212, and a “TIME” field 214 that each present different types of contextual information. More specifically, for each voicemail message represented in the identification region 206, contextual information corresponding to the fields 210-214 is presented, if the information is available. In this regard, the “STATUS” field 210 indicates whether a voicemail message has been previously played to the user. Similarly, in the “FROM” field 212 and the “TIME” field 214, the identity of the caller and the time when the call was received are displayed. However, the fields 210, 212, and 214 depicted in FIG. 2A should be construed as exemplary as other types of contextual information may be displayed. For example, a user may define preferences to display the importance of a voicemail message, any file attachments, duration of voicemail messages and the like. By way of additional examples, controls that allow a user to access entries in a database commonly known as an “address book” may be presented in a field on the user interface 200. By selecting this type of control from the user interface 200, additional information about the author of a selected voicemail message may be readily obtained. Moreover, fewer or additional fields may be presented to the user than those depicted on the selection user interface 200.

The sidebar region 204 includes a plurality of selectable controls including a “CONTACTS” button 214, a “MESSAGES” button 216, and a “CALL LOG” button 218. In one embodiment, when the “CONTACTS” button 214 is activated, data maintained in the address book is displayed. The data displayed in response to the “CONTACTS” button 214 being activated allows the user to select a particular contact. When a contact is selected, the user may initiate a call to the contact by activating another control accessible from the selection user interface 200. For example, the control region 208 includes a “CALL” button 220 for initiating a call to the author of a selected voicemail message.

When the “MESSAGES” button 216 is activated, contextual information related to the user's received voicemail message is presented in the identification region 206. In this regard, FIG. 2B illustrates the type of contextual information that may be presented in response to the “MESSAGES” button 216 being activated. Also, by activating the “CALL LOG” button 218, the user may access contextual information related to each incoming/outgoing telephone call.

From the exemplary selection user interface 200 depicted in FIG. 2A, a user may generate an event to listen to one or more received voicemail messages. For example, a user may activate the “PLAY ALL” button 222 or the “PLAY” button 224 from the control region 208. In response, a navigation user interface 250 (FIG. 2B) may be displayed. Among other things, the navigation user interface 250 provides controls for navigating between received voicemail messages. In this way, aspects of the present invention allow a user to selectively process received voicemail messages from an IP phone.

For illustrative purposes and by way of example only, an exemplary navigation user interface 250 is depicted in FIG. 2B. In this example, a control accessible from the selection user interface 200 was activated to initiate playback of a selected voicemail message. In response, the navigation user interface 250 is displayed that presents detailed contextual information about the selected voicemail message. Similar to the description provided above, the navigation user interface 250 includes a sidebar region 204, an identification region 206, and a control region 208.

In accordance with one embodiment, the controls available from the sidebar region 204 are constant between different user interfaces. This allows a user to readily navigate between user interfaces and voicemail messages that are of interest to the user while using an IP phone. In any event, when a voicemail message is being played, the identification region 206 presents contextual information associated with a selected voicemail. More specifically, in the example depicted in FIG. 2A, the identification region 206 includes a “FROM” entry 260, “SUBJECT” entry 262, “IMPORTANCE” entry 264, and a “SENSITIVITY” entry 266. The contextual data presented in the entries 260-266 may be obtained from the metadata in the received voicemail message. In accordance with one embodiment, metadata is extracted from an electronic file that stores the voicemail message for display to the user.

In this regard, the identification region 206 includes a “FROM” entry 260 that identifies the author of the selected voicemail message. Moreover, the identification region 256 depicted in FIG. 2B also includes a “SUBJECT” entry 262. Text input by the author of the voicemail message may be included in the “SUBJECT” entry 262 depicted in FIG. 2A. Also, the text displayed in the “SUBJECT” entry 262 may be “mined” from the body of a voicemail message using voice recognition technology. Moreover, the identification region 206 includes an “IMPORTANCE” entry 264 and a “SENSITIVITY” entry 266 that identify the relevant importance and sensitivity of the selected voicemail message, respectively.

As further illustrated in FIG. 2B, the identification region 206 includes a plurality of selectable controls including a “STOP” button 268, a “NEXT” button 270, a “DELETE” button 272, and a “REPLY” button 274. By selecting the “STOP” button 268, a user issues a command to terminate the playback of the voicemail message. As the body of the voicemail message is being played, a user may activate the “NEXT” button 270 to terminate playback of the current voicemail message and initiate playback of a subsequent voicemail message. Similarly, a user may activate the “DELETE” button 272 to terminate playback of the current voicemail message and prevent the voicemail message from being stored in the user's voicemail box. Generally described, these controls available from the selection user navigation user interface 250 allow a user to quickly navigate between received voicemail messages so that a user may easily access desired information.

A user may activate the “REPLY” button 274 to initiate a communication with the author of the selected voicemail message. In one embodiment, activation of the “REPLY” button 274 initiates a call to the author of the voicemail message. In an alternative embodiment, a user may reply by recording a new voicemail message that will be transmitted to the author of the original voicemail message. In this instance, audio data is captured using the hardware provided by the user's IP phone.

Generally described, aspects of the present invention implement processing that allows contextual information associated with a user's voicemail messages to be displayed on an IP phone. In one embodiment, input is obtained from a touch panel that displays a user interface. From the user interface, the user may interact with the touch panel and generate events to, among other things, (1) listen to one or more voicemail messages; (2) navigate between voicemail messages; and/or (3) initiate a communication with another user based on the contextual information available from the user interface. In order to provide this functionality from an IP phone, processing is performed by aspects of the present invention to exchange control information between remote devices.

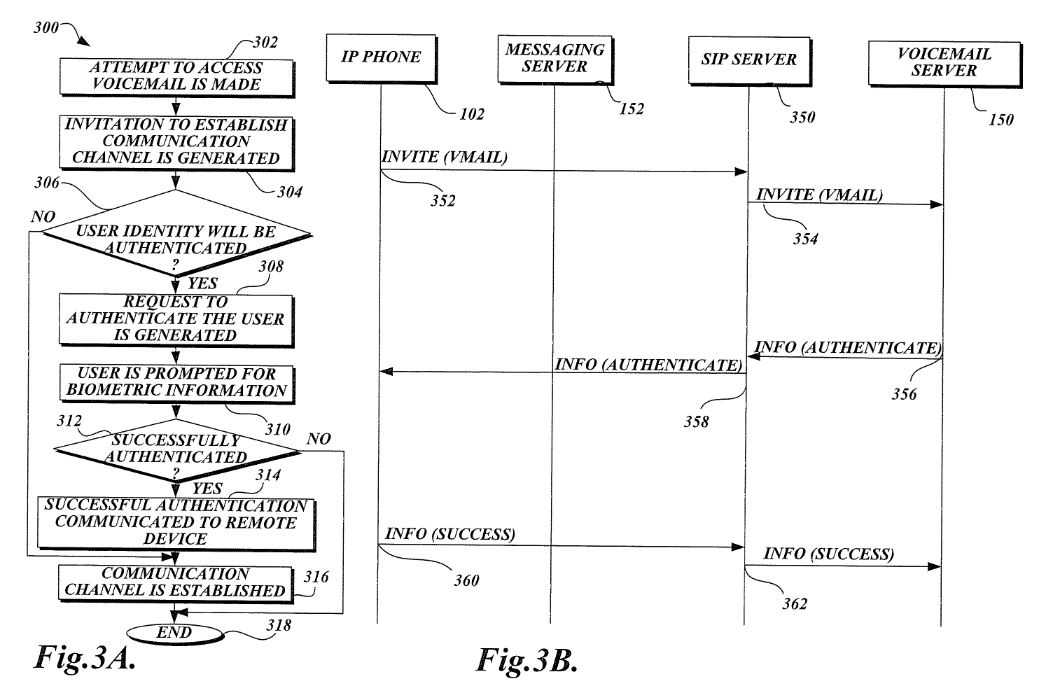

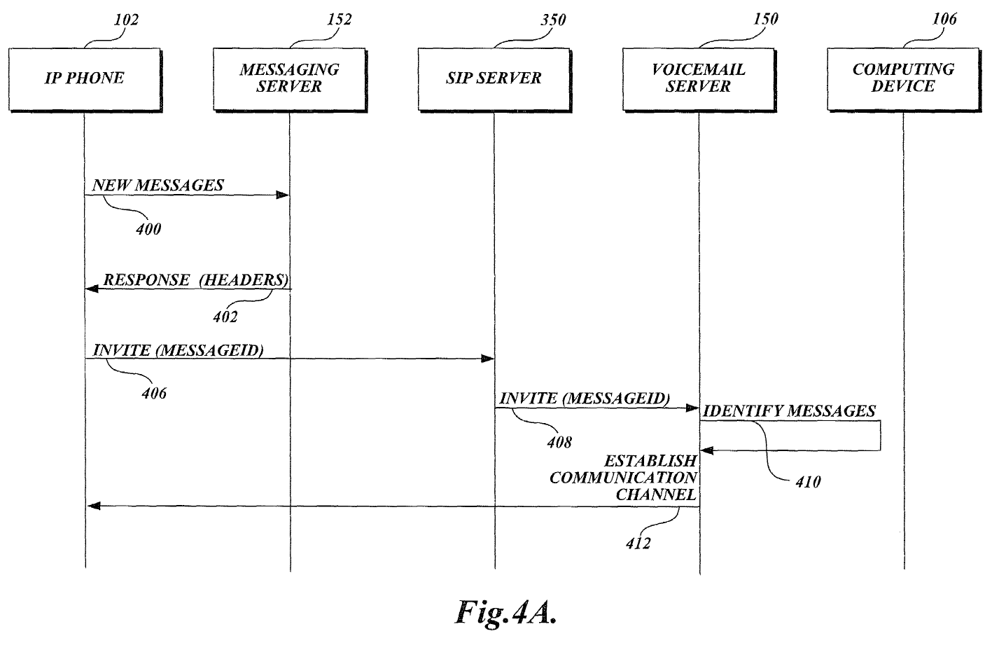

Now, with reference to FIGS. 3A-3B, an exemplary authentication routine 300 for authenticating a user in accordance with an embodiment of the present invention will be described. For illustrative purposes, various steps performed by the authentication routine 300 are illustrated in FIG. 3A. Moreover, an exemplary exchange of control information between remote devices that corresponds to steps performed during the authentication routine 300 (FIG. 3A) is depicted in FIG. 3B. In this regard, FIG. 3B depicts various devices previously described above with reference to FIGS. 1A-1B. More specifically, FIG. 3B depicts the IP phone 102 that is associated with a user who received a voicemail message, the voicemail server 150, the messaging server 152, and the computing device 106 that is associated with a user who sent a voicemail message. Moreover, FIG. 3B depicts a SIP server 350 that is communicatively connected to the IP phone 102, the voicemail server 150, the messaging server 152, and the computing device 106. Those skilled in the art and others will recognize that the SIP server 350 provides infrastructure to support real-time communications over an IP data network. The infrastructure provided by the SIP server 350 allows a communication channel to be established for transmitting a voicemail message between remote devices.

As illustrated in FIG. 3A, the authentication routine 300 begins at block 302 where an attempt to access contextual information associated with one or more voicemail messages is made. For example, a user may generate input to obtain contextual information about the user's new voicemail message. In this regard, the “MESSAGES” button 216 may be activated to obtain contextual information about the user's new voicemail messages. When the control is activated, processing performed by aspects of the present invention obtains contextual information associated with a user's voicemail messages for display on the IP phone 102. Also, an IP phone may periodically poll a remote device to automatically obtain contextual information associated with a user's voicemail messages.

At block 304, an invitation to establish a communication channel with a device that manages a user's voicemail messages is generated. In this illustrative embodiment, generating the invitation to establish the communication channel includes transmitting a series of control messages between remote devices. For example, as depicted in FIG. 3B, a SIP-based invite message with argument(s) configured to establish a communication channel with a device that manages contextual information associated with a user's voicemail messages is transmitted from the IP phone 102 to the SIP server 350, at event 352. Then the SIP server 350 causes the received invite message to be forwarded to the voicemail server 150, at event 354.

Those skilled in the art and others will recognize that control messages, such as the invite message transmitted at events 352-354, are typically exchanged in request/response pairs. In this context, the request initiates an action while the response acknowledges the successful receipt of the request. For example, in response to receiving the invite message at event 352, the SIP server 350 transmits a response message (not illustrated) back to the IP phone 102 that acknowledges the successful receipt of the invite message. In some instances, the transmission of the response messages has not been described or illustrated herein because these messages may not be important for an understanding of the present invention. Instead, the description provided herein describes exemplary exchanges of control information that are based on the successful receipt of requests.

Returning to FIG. 3A, at block 306, a determination is made regarding whether the identity of the user will be authenticated. In this example, the voicemail server 150 processes the invite message received at event 354 to identify the user who is attempting to access data from a voicemail box. Then a lookup of the user's voicemail account settings is performed to determine whether the settings dictate that the identity of this user will be authenticated. If the result of the test performed at block 306 is “NO,” the authentication routine 300 proceeds to block 316, described in further detail below. If the result of the test performed at block 306 is “YES,” the authentication routine 300 proceeds to block 308.

At block 308, a request to authenticate the user is generated. In existing voicemail systems, the identity of a user has typically been authenticated by requiring the user to manually enter a secret identifier such as a “password” or “PIN” number. As described in further detail below, aspects of the present invention provide an enhanced authentication system in which a user is not required to manually enter this type of identifier. In any event, generating the request to authenticate the user, in this illustrative embodiment, includes transmitting a series of control messages between remote devices. For example, as depicted in FIG. 3B, a SIP-based info message with argument(s) configured to prompt the user for authentication information is transmitted from the voicemail server 150 to the SIP server 350, at event 356. Then the SIP server 350 causes the received info message to be forwarded to the IP phone 102, at event 358.

As illustrated in FIG. 3A, at block 310, a prompt to enter biometric information is presented on the user interface of the user's IP phone. In an exemplary embodiment, the biometric information accepted from the IP phone is the fingerprint of the user. However, those skilled in the art and others will recognize that other types of biometric information may be used to authenticate the identity of the user without departing from the scope of the claimed subject matter. Then, at block 312, a determination is made regarding whether the biometric information received at block 310 matches biometric information previously obtained from the user. If the received biometric information does not authenticate the identity of the user, the authentication routine 300 proceeds to block 318, where it terminates. In this instance, additional attempts to authenticate the user may be performed. Conversely, if the identity of the user is authenticated, the authentication routine proceeds to block 314.

As illustrated in FIG. 3A, at block 314, an IP phone communicates the successful authentication of the user to a device that manages the user's voice voicemail messages. In this illustrative embodiment, communicating the successful authentication of the user includes transmitting a series of control messages between remote devices. For example, as depicted in FIG. 3B, a SIP-based info message with argument(s) that indicate that the user was successfully authenticated is transmitted from the IP phone 102 to the SIP server 350, at event 360. Then, the SIP server 350 causes the received info message to be forwarded to the voicemail server 150, at event 362.

Returning to FIG. 3A, a communication channel between the appropriate devices is established at block 316. If block 316 is reached, a user was successfully authenticated and may access information from a voicemail box. When the communication channel is established, the user may generate various requests to obtain desired information. For example, a user may generate a request from the user interfaces described above with reference to navigate between received voicemail messages. Then, the authentication routine 300 proceeds to block 318, where it terminates.

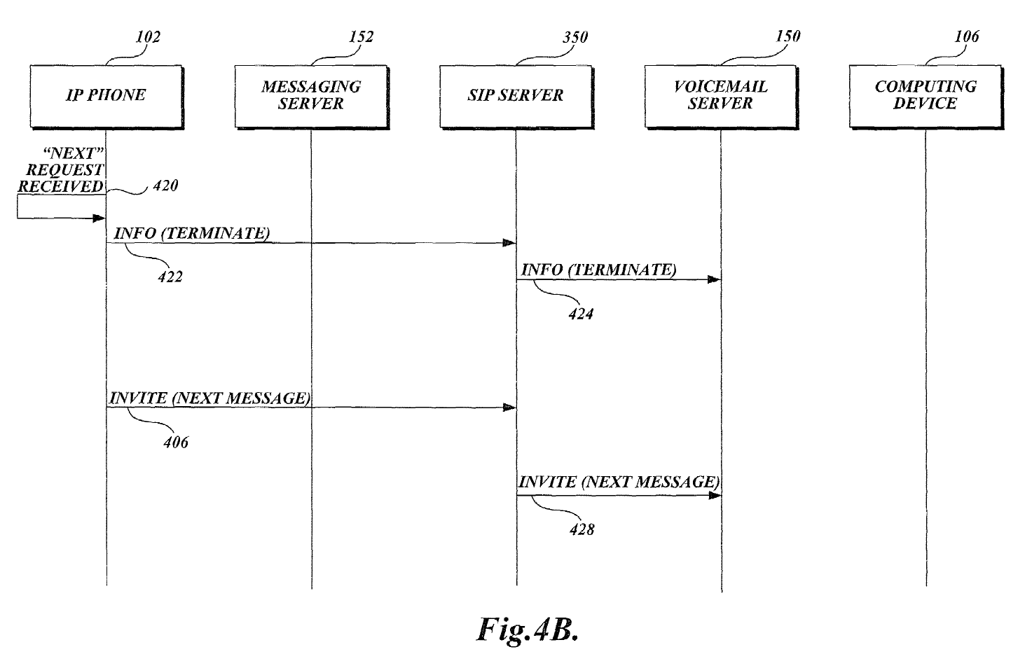

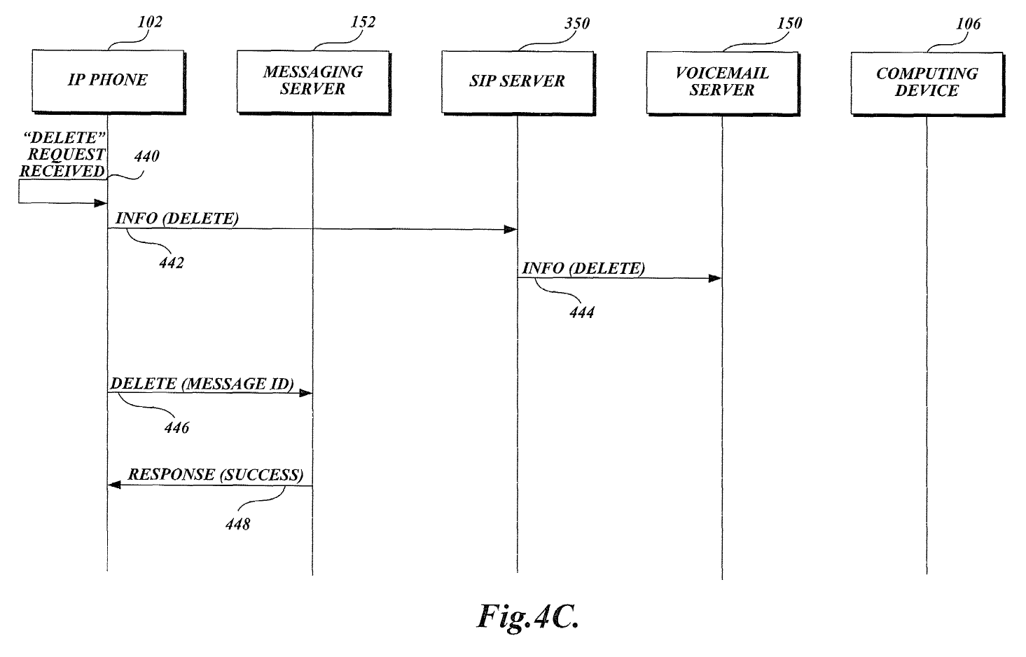

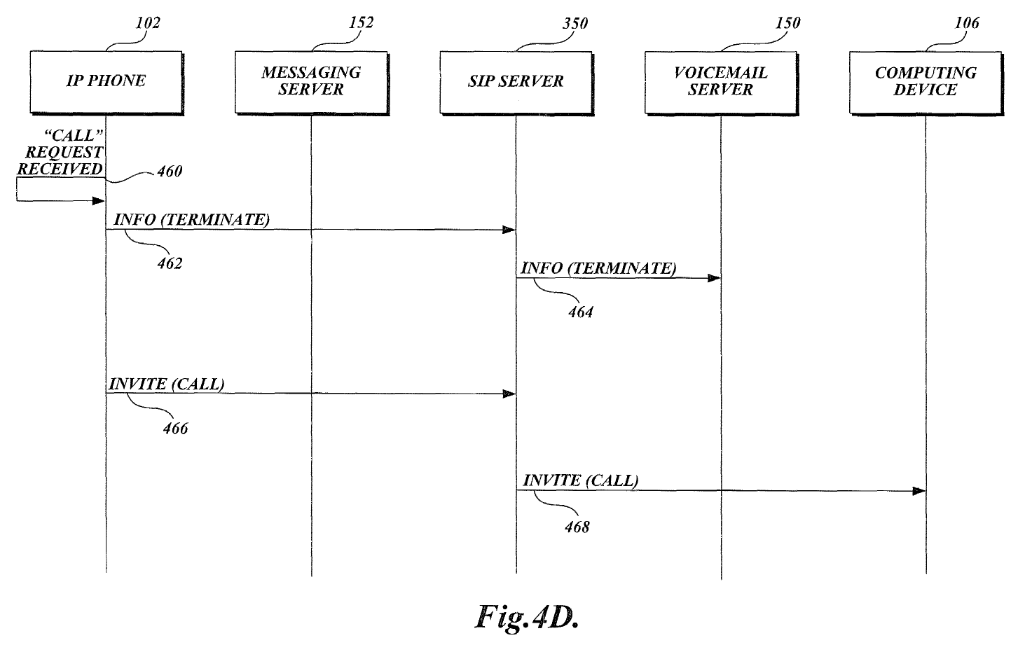

Now, with reference to FIGS. 4A-4D, an exemplary exchange of control information for performing various functions supported by the present invention will be described. In this regard, FIGS. 4A-4D each depict the IP phone 102, the voicemail server 150, the messaging server 152, the computing device 106, and the SIP server 350 described above. Each of the functions described with reference to FIGS. 4A-4D may be activated from the user interface of an IP phone provided by aspects of the present invention.

Generally described, FIG. 4A illustrates an exemplary exchange of control information that occurs when contextual information about a user's new voicemail messages is transmitted to an IP phone. In this illustrative embodiment, the IP phone 102 issues a function call with arguments for obtaining contextual information associated with the user's new voicemail messages to the messaging server 152, at event 400. As mentioned previously, the IP phone 102 may be configured to periodically “poll” the messaging server 152 for contextual information associated with a user's new voicemail messages. Also, the function call transmitted to the messaging server 152, at event 400, may be generated in response to a user manually activating a control from the user interface of the IP phone 102. In one embodiment, the function call generated on the IP phone 102 is configured to access a Web service exposed by the messaging server 152 that is responsible for obtaining the requested data.

When the function invoked on the messaging server 152 completes executing, a response that includes the requested contextual information is transmitted back to the IP phone 102, at event 402. In this illustrative embodiment, the data transmitted to the IP phone 102, at event 402, includes metadata in the “header” of the user's voicemail messages. Upon receipt of the response, contextual information related to the user's new voicemail messages may be displayed on the user interface of the IP phone 102. In this regard, exemplary user interfaces that display contextual information are described above with reference to FIGS. 2A-2B.

From user interfaces provided by aspects of the present invention, a user may provide input to play specific types of voicemail messages. For illustrative purposes, FIG. 4A provides an example in which a user requests that new voicemail messages with an importance of “HIGH” be played on the IP phone 102. When this type of request is input on the IP phone 102, a SIP-based invite message with arguments to play new voicemail messages with an importance of “HIGH” is transmitted to the SIP server 350, at event 406. Then the SIP server 350 forwards the SIP-based invite message to the voicemail server 150, at event 408.

When the SIP-based invite message is received, processing is performed on the voicemail server 150 to identify voicemail messages that match the criteria identified in the request. More specifically, at event 410, the voicemail server 150 identifies all of the new voicemail messages that are assigned an importance of “HIGH.” Then, at event 412, a communication channel for transmitting audio data is established between the voicemail server 150 and the IP phone 102. Thereafter, the voicemail messages that match the selected criteria are sequentially streamed from the voicemail server 150 to the IP phone 102. As described in further detail below, as voicemail messages are being streamed, input may be received that causes playback of a voicemail message to be suspended.

FIG. 4B illustrates an exemplary exchange of control information that occurs when a user provides input to suspend playback of a current voicemail message so that a subsequent voicemail message may be played. Similar to the description provided above, aspects of the present invention cause control information to be exchanged between remote devices. In this example, the exchange of control information causes playback of the current voicemail message to be suspended so that a subsequent voicemail message may be played. The embodiment illustrated in FIG. 4B depicts the exchange of control information in instances when the voicemail server 150 is limited in its ability to directly satisfy SIP-based requests. However, aspects of the present invention may be implemented in a system in which the voicemail server 150 directly handles SIP-based requests that are received from a remote device. Thus, the embodiment depicted in FIG. 4B should be construed as exemplary and not limiting as aspects of the present invention may be applied in other contexts.

For illustrative purposes, FIG. 4B provides an example in which a user generates a request, at event 420, to suspend playback of the current voicemail message so that a subsequent voicemail message may be played. In this regard, and as described above with reference to FIG. 2B, a user may activate the “NEXT” button 270 from the user interface 250 in order to “skip” the current voicemail message. In response, a SIP-based info message is transmitted from the IP phone 102 to the SIP server 350, at event 422. Then, the SIP server 350 forwards the info message received from the IP phone 102 to the voicemail server 150, at event 424. The SIP-based info message contains arguments configured to terminate the streaming of audio data packets associated with the current voicemail message.

When the SIP-based info message is received at the voicemail server 150, processing is performed to suspend the transmission of audio data associated with the current voicemail message. In this regard, the voicemail server 150 may transmit a response message (not illustrated) to the IP phone 102 to indicate that the transmission of audio data associated with the current voicemail message was successfully terminated. In response to receiving the response message, a SIP-based invite message is generated and transmitted from the IP phone 102 to the SIP server 350, at event 426. The invite message includes arguments requesting that a subsequent voicemail message be played on the IP phone 102. Then, the SIP server 350 forwards the invite message received from the IP phone 102 to the voicemail server 150, at event 428. Thereafter, audio data associated with the subsequent voicemail message is streamed from the voicemail server 150 to the IP phone 102 for playback to the user.

In an alternative embodiment, the voicemail server 150 may directly handle SIP-based requests for suspending playback of a voicemail message. In this instance, a single SIP-based message may be directly transmitted from the IP phone 102 to the voicemail server 150 without being processed by the SIP server 350. The message may be configured with arguments that both terminate transmission of audio data associated with the current voicemail message and initiate transmission of the subsequent voicemail message.

For illustrative purposes, FIG. 4C provides an example in which a request directed at deleting the current voicemail message from the user's voicemail box is generated, at event 440. In this regard and as described above with reference to FIG. 2B, a user may activate the “DELETE” button 272 from the user interface 250 in order to generate this type of request. In response, a SIP-based info message is transmitted from the IP phone 102 to the SIP server 350, at event 442. Then, the SIP server 350 forwards the info message to the voicemail server 150, at event 444. The SIP-based info message contains arguments configured to suspend the streaming of audio data packets associated with the current voicemail message. Moreover, the SIP-based info message contains arguments to indicate that the selected voicemail message should not be maintained on mass storage.

When the SIP-based info message is received at the voicemail server 150, processing is performed to suspend the transmission of the audio data associated with the current voicemail message. Moreover, processing is performed so that the current voicemail message is “marked” for deletion. The voicemail server 150 may transmit a response message (not illustrated) to the IP phone 102 indicating that the current voicemail message was successfully deleted. In response to receiving the response message, a function call is generated and transmitted from the IP phone 102 to the messaging server 152, at event 446. The function call is configured with arguments indicating that the current voicemail message has been “marked” for deletion. As a result, contextual information associated with the current voicemail message may also be deleted from storage maintained by the messaging server 152. In response to executing the function, a response that indicates whether the voicemail message was successfully deleted is transmitted back to the IP phone 102, at event 448.

Similar to the description provided above with reference to FIG. 4B, the voicemail server 150 may directly handle SIP-based requests for deleting a voicemail message in an alternative embodiment of the present invention. In this instance, a SIP-based message may be directly transmitted from the IP phone 102 to the voicemail server 150 for deleting a selected voicemail message without being processed by the SIP server 350.

For illustrative purposes, FIG. 4D provides an example in which a user generates a request, at event 460, to generate a reply to the current voicemail message. In this regard and as described above with reference to FIG. 2B, a user may activate the “CALL” button 220 from the user interface 200 to initiate a real-time communication with the author of a received voicemail message. In response, a SIP-based info message is transmitted from the IP phone 102 to the SIP server 350, at event 462. The SIP-based info message contains arguments configured to suspend the streaming of audio data packets associated with the current voicemail message. Then, the SIP server 350 forwards the info message received from the IP phone 102 to the voicemail server 150, at event 464.

When the SIP-based info message is received at the voicemail server 150, processing is performed to suspend the transmission of the audio data associated with the current voicemail message. In this regard, the voicemail server 150 may transmit a response message (not illustrated) to the IP phone 102 indicating that transmission of audio data associated with the current voicemail message was successfully terminated. In response, a SIP-based invite message is generated and transmitted from the IP phone 102 to the SIP server 350, at event 466. The invite message includes arguments requesting that a call be initiated with the author of the received voicemail message. Then, the SIP server 350 forwards the invite message to the computing device 106 associated with the author of the voicemail message. Those skilled in the art and others will recognize that receipt of the invite message may cause the computing device 106 to alert the author of the voicemail message of an incoming call. Accordingly, if the call is answered, a communication channel is established for communicating audio over a real-time communication channel.

While illustrative embodiments have been illustrated and described, it will be appreciated that various changes can be made therein without departing from the spirit and scope of the invention.

The embodiments of the invention in which an exclusive property or privilege is claimed are defined as follows:

1. In a networking environment operative to transmit data between remote devices, a method of providing access to contextual information related to one or more voicemail messages from a user interface of an IP phone, the method comprising:
storing the one or more voicemail messages on a server computer that is communicatively connected to the IP phone;
extracting contextual information from metadata in the one or more voicemail messages;
in response to receiving a request from the IP phone, transmitting the contextual information extracted from metadata of the one or more voicemail messages that is responsive to the request from the server computer to the IP phone; and
displaying the contextual information on the user interface of the IP phone.

2. The method as recited in claim 1, further comprising:
accepting input to play a voicemail message represented in the displayed contextual information; and
communicating the input to play the voicemail message to the server computer; and
streaming the voicemail message from the server computer to the IP phone.

3. The method as recited in claim 1, further comprising:
accepting input to navigate between the one or more received voicemail messages; and
satisfying the command to navigate between the one more received voicemail messages.

4. The method as recited in claim 3, wherein commands to navigate between the one or more voicemail messages include commands to terminate playback of the current voicemail message and initiate playback of a subsequent voicemail message.

5. The method as recited in claim 1, wherein the contextual information is displayed automatically without the user being required to provide input in response to a prompt.

6. The method as recited in claim 1, wherein the contextual information is transmitted from the server computer to the IP phone without the body of a voicemail message being transmitted.

7. The method as recited in claim 1, wherein contextual information associated with a plurality of voicemail messages is concurrently displayed on the user interface, and wherein the user may selectively identify a voicemail message from the user interface for playback on the IP phone.

8. The method as recited in claim 1, wherein transmitting contextual information extracted from metadata of the one or more voicemail messages includes exposing a Web service on the server computer that executes functions calls received from a remote device.

9. The method as recited in claim 1, wherein the contextual information displayed to the user interface includes the voicemail message author, subject, importance, duration, and time.

10. The method as recited in claim 1, wherein the extracted contextual information may be stored on a separate computing device or on the same computing device as the audio data associated with the one or more voicemail messages.

11. A user interface on an IP phone that presents contextual information associated with one or more voicemail messages, the user interface configured to:
receive contextual information associated with the one or more voicemail messages from a remote device;
display the contextual information on the IP phone and accept input to play a voicemail message represented in the displayed contextual information; and
while the voicemail message is being played:
accept input to navigate between the one or more voicemail messages; and
communicate the input received from the user to the remote device.

12. The user interface as recited in claim 11, wherein the input to play a voicemail message is obtained from a touch screen that displays a selection user interface that automatically presents the contextual information received from the remote device.

13. The user interface as recited in claim 11, wherein the input accepted for navigating between the one or more voicemail messages includes a command to skip playback of the voicemail message and initiate playback of a subsequent voicemail message.

14. The user interface as recited in claim 11, wherein the input accepted for navigating between the one or more voicemail messages includes a command to terminate playback of the voicemail message.

15. The user interface as recited in claim 11, wherein the input accepted for navigating between the one or more voicemail messages includes a command to delete the voicemail message from storage in a voicemail box.

16. The user interface as recited in claim 11, wherein the contextual information displayed includes a status as to whether the user previously listened to the voicemail message.

17. The user interface as recited in claim 11, wherein the contextual information displayed includes an importance of the voicemail messages as assigned by the author of the voicemail message.

18. A computer system for providing a user with access to contextual information associated with one or more voicemail messages, comprising:
at least one sending device operable to transmit a voicemail message over a communication network;
a voicemail platform configured to:
store one or more voicemail messages in a voicemail box associated with the user; and
transmit contextual information associated with the one or more voicemail messages to the IP phone; and
an IP phone associated with the recipient of the voicemail message configured to:
display the contextual information on a user interface; and
accept input to navigate between the one or more voicemail messages from the user interface and communicate the input to the voicemail platform.

19. The system as recited in claim 18, wherein the audio data associated with the one or more voicemail messages is maintained on a voicemail server, and wherein contextual information associated with the voicemail messages is maintained on a messaging server.

20. The system as recited in claim 18, wherein the contextual information is transmitted from the voicemail platform to the IP phone without the concurrent transmission of audio data associated with the one or more voicemail messages.
